(19) United States
(12) Patent Application Publication
(10) Pub. No.: US 2002/0120834 A1
(43) Pub. Date: Aug. 29, 2002

(54) Klyako computer

(76) Inventor: Edin Kljako, Chicago, IL (US)

Correspondence Address: Edin Kljako, 4945 North Bell Street, Chicago, IL, 60625, US

(21) Appl. No.: 09/793,170

(22) Filed: Feb. 26, 2001

(51) Int. Cl. G06F 9/00

(52) U.S. Cl. 713/1

(57) ABSTRACT

A newly designed motherboard, one each for desktop, laptop, and notebook computers, that would be used for storing operating system programs and files on a programmable rom chip(non-erasing). A programmable rom chip, of about 300 megabytes in size, enough to hold a large operating system and the system bios, is installed on the motherboard. A hard disk would only be used to store applications programs and files. Instead of ram, there would be a programmable rom chip of about 64 megabytes (the programs would load into this programmable rom chip, similar to ram). Portable prom chips would be used to upgrade the size of the prom(ram).

### CROSS REFERENCE

Not Applicable

### FEDERALLY SPONSORED RESEARCH

Not applicable

### REFERENCE TO MICROFICHE APPENDIX

Not applicable

### BACKGROUND OF THE INVENTION

This invention pertains generally to computer systems; in particular, a computer that employs the use of a programmable rom chip, of 300 megabytes or more, to store system files and programs, resulting in the elimination of a wait period for the loading of an operating system. There is another programmable rom chip that replaces the ram on a system; this programmable rom chip allows the user to turn off the computer, turn it on again, and start where he left off before he turned the machine off.

This invention is an improvement to “bios” that other computer manufacturers incorporate in their system architectures. Not only does the programmable rom chip carry the system bios(files on a programmable rom chip that control peripheral operations, but rather, the operating system is stored on the programmable rom chip as well. This will eventually lead to the elimination of the hard disk as we know it(As soon as technology allows for the production of large capacity programmable rom chips).

This invention also eliminates ram as we know it. Ram is replaced by a programmable rom chip. This makes programs and files remain in memory until removed manually by the user. A person is able to turn the computer off(saving precious battery time on a laptop or notebook computer) and turn the computer back on again to start at the same place where he left off. Absolutely no waiting period(loading of the operating system, re-initiating the program that user was using, opening the file or files that the user was using).

Computer systems generally use a hard disk to store operating system files and programs. Files and programs for external peripherals are stored in system bios. In order for a person to start his computer, he would have to wait for the operating system to load itself into memory. The time period required to load these programs into ram is usually a few seconds and more, depending on the age of the computer.

The present invention places the system and program files necessary to operate the computer in the programmable memory chip; it also stores the operating system(windows or dos) on the same chip. This eliminates the time required to load programs and files into ram(new programmable rom chip). It employs a programmable rom chip to store the operating system and support files. These files would be constantly in memory. The only thing that the user would be required to do is turn on the monitor and call up the program that he wishes to use.

### BRIEF SUMMARY OF THE INVENTION

It is the object of this invention to provide a computer with a programmable memory chip that would hold an operating system's files and programs, eliminating the time required to load a large operating system. This computer system would allow the emergence of a first disk(programmable rom chip) and a second disk(hard disk) for storing files and programs not associated with the operating system. The hard disk will be eliminated as soon as technology allow the production of large capacity programmable rom chips.

This invention makes the personal computer or notebook computer “always on,” much like the personal digital assistant or calculator. This embellishes the general computer design and operation. It is very similar to a personal digital assistant or calculator design, however, this is a larger desktop or notebook-laptop computer.

### BRIEF DESCRIPTION OF THE SEVERAL VIEWS OF THE DRAWING

Not applicable

### DESCRIPTION OF THE PREFERRED EMBODIMENT

The KLYAKO COMPUTER employs a programmable rom chip on the mother board. The rom chip is an embellishment on computer architecture that makes everyday starting and shutting down a computer much quicker and easier. This chip will be used to the store an entire operating system and programs and files that control peripheral operations(bios). This eliminates a wait time required for an operating system to load into ram(programmable rom chip in this computer). This also eliminates the wait time required for a system to shut down.

What I have done is made a computer that is on all the time and shuts down as easy as it starts. The operating system is not stored in ram, however; it is stored in the programmable rom chip(this rom chip operates like the bios chip that registers your hard disk or updates the time on a computer). This invention will also allow the user to save precious battery time on a notebook or laptop computer by allowing the user to shut down the computer then restart the computer to continue exactly where we left off.

When installing a new peripheral, internal or external, the information in the rom chip would be upgraded by a special program developed for the new architecture. In other words, the rom chip would be manipulated by an operating system program to allow the addition of a new peripheral or the addition of an improvement to an existing program. In order to remove a program or file from memory, the same program would be used.

What is claimed is:

1. A programmable rom chip is installed on a motherboard. This chip is to contain not only the bios of the computer, but the operating system(windows or other) as well. This eliminates the time required for loading an operating system, thus speeding start and shut down operations for an end user. System files that control peripherals, resources such as disk drive, printer, monitor, and etc., would be stored on the same programmable rom chip(an expansion of bios).

2. A programmable rom chip, of about 64 megabytes, would be installed on the motherboard to act as ram. This would be in addition to the programmable rom chip containing bios and the operating system. Programs would be removed from memory simply by using a task bar or a task application.

3. A hard disk drive would be used only for storing files and programs not related to the system's files or programs, such as database programs, spreadsheets, word processing programs, user files, etc.
This makes the regular computer allways on. It speeds the start and shut down process that a user has to go through every visit to his computer. A person could shut off his computer in the middle of his work, turn it back on again, and start where he left off.
